(19) United States
(12) Patent Application Publication
(10) Pub. No.: US 2002/0140701 A1
(43) Pub. Date: Oct. 3, 2002

(54) Method and system for constructing and visualizing color gamuts

(76) Inventor: Karl E. Guyler, Bucyrus, KS (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/824,353

(22) Filed: Apr. 2, 2001

(51) Int. Cl. G06T 1/00; G06F 15/00

(52) U.S. Cl. 345/501

(57) ABSTRACT

A method and system for constructing and visualizing color gamuts allows the color gamut of a ink system with more than four colors to be constructed from a plurality of color data points for colors printed with the ink system. The color data points are put in an additive color space, such as the CIE-XYZ space, and a convex hull is constructed from the color data points. The convex hull is then transferred from the additive color space into a corresponding solid object in a psychometric color space, such as the CIE Lab color space. The solid object represents the color gamut of the ink system and can be displayed as a 3-D object for visualization of the color gamut. The volume of the color gamut can be calculated for comparing with other gamuts. Two or more color gamuts can be displayed together to contrast the differences between them.

### TECHNICAL FIELD OF THE INVENTION

This invention relates generally to the art of reproducing colors, and, more particularly, this invention addresses the need for an effective way to construct, present, and analyze the color gamuts of different ink systems.

### BACKGROUND OF THE INVENTION

Color is an immensely complex subject that draws on concepts and results from physics, physiology, and psychology. A huge amount of efforts has been devoted in developing various color theories, measurement techniques, and color standards. One of the most important motivations to achieve a better understanding of color is the desire to reproduce, such as by printing, the full spectrum of colors seen in real life. The reproduction of colors, however, can be a very challenging matter even for experts in that field.

For instance, one important yet often not well-answered question for those in the printing industry is what colors can be produced from a pre-selected set of ink colors. The collection of all the possible colors that can be produced from those given ink colors is called the “gamut” of that ink set. For instance, conventional four-color printing uses four ink colors: cyan, magenta, yellow, and black (CMYK). Even with these traditional printing colors, color variations between inks produced by different companies can cause significant inconsistency in the printed colors. For nearly 40 years, a small segment of the printing industry has also been printing with six process inks. Modern examples include the BigBox Color™ ink system of Hallmark Cards, Inc., which uses pink and light cyan in addition to the conventional four colors, and the Hexachrome® system of Pantone, which adds orange and green to the conventional mix. Some color ink systems add fluorescent colors to print colors that cannot be printed with conventional ink colors. With the different set of inks, it is often necessary to answer questions as to whether a particular color can be printed using a given set of inks, what printable colors are gained by going from four ink colors to six ink colors, what colors can be printed with one ink set but not the other, etc.

Prior to this invention, such questions were often very difficult to answer and to quantify. Ironically, the difficulties in answering those questions about colors are generally due to the inability to “visualize” the color gamut of a given set of inks. For instance, the traditional way of looking at the printable colors is to present the projection of the color gamut in the a*-b* plane of the CIE Lab color space or in an x-y chromaticity coordinate diagram. Such two-dimensional presentations are of very limited usefulness in predicting available colors or comparing color gamuts of different ink sets. They give no consideration to the lightness dimension.

Recently, a commercial software program called “Color3D” has been used to present color gamuts of conventional 4-color ink systems. This program presents the 4-color gamut in the CIE-Lab space as a three-dimensional (3-D) image object. The color gamut has the shape of a deformed cube, with the vertices corresponding to the minimum set of test colors white, black, the yellow, cyan, magenta colors, and the blue, red, and green colors generated by mixing the primary inks. The curved faces of the color gamut cube are determined from the connectivity of the vertices based on the principles of the Neugebauer equations known to those skilled in the art. The curved faces are painted with interpolated color. Although the display of the color gamut as a 3-D object is very useful for the visualization of the color gamut, Color3D's painted gamut objects can only be derived for the conventional 4-color ink system and cannot be used for any ink systems using any additional ink color.

In this regard, it should be appreciated that the inability to visualize the color gamut of an ink set with more than the conventional four ink colors is related to the fundamental problem of not knowing how to construct the color gamut from the given ink colors. With a conventional 4-color system, once the color data points corresponding to the vertices of the color cube are identified, the gamut can be determined based on the Neugebauer model. When more ink colors are used, however, there is no theoretical guidance as to how the color gamut can be derived from the color data points. Before the present invention, there was no reliable and effective way to estimate and present the color gamuts of ink sets with additional colors for visualization and analysis purposes.

### SUMMARY OF THE INVENTION

In view of the foregoing, the present invention provides a method and system that can be used for constructing and presenting the color gamut of a selected set of ink colors such that the color gamut can be visualized, analyzed, and compared with the color gamuts of other ink systems. In accordance with the invention, a plurality of color data points, which may correspond to the printable colors of an ink system, are collected. The color data points are put in an additive color space, such as the CIE XYZ space, and a convex hull is constructed in that color space from the color data points. The convex hull is then transformed from the additive color space into a corresponding solid object in a psychometric color space, such as the CIE Lab color space, by applying an appropriate color space transformation. The solid object represents the color gamut in the psychometric color space for the color data points.

After a color gamut is mathematically defined in accordance with the invention, its gamut volume and surface area can be calculated to allow quantitative comparisons with other color gamuts. Furthermore, the color gamut can be displayed as a 3-D solid object on a display device for visualization. Two or more color gamuts can also be displayed together to contrast their differences. Gamut visualization can also be applied to characterize display devices such as computer displays, liquid crystal displays and digital projectors. Comparison of the gamuts of these with printed media provides information as to the suitability and limitations of the devices for image creation, prepress image processing, and “soft proofing” to depict the final printed product.

Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram illustrating a process of constructing a color gamut from a plurality of color data points in accordance with the invention;

FIGS. 2A-C are diagrams showing selected colors provided by a 4-color ink system, a 5-color ink system, and a 6-color color system;

FIG. 3A shows a convex hull in the CIE XYZ color space constructed from color data points for the colors of the 5-color ink system shown in FIG. 2B;

FIG. 3B shows a color gamut in the CIE Lab color space derived from the convex hull shown in FIG. 3A;

FIG. 4 shows a comparison of the color gamut of the 4-color ink system with the color gamut of the 6-color ink system of FIG. 2;

FIG. 5 shows a comparison of the color gamuts of two 6-color ink systems; and

FIG. 6 is a schematic diagram showing a computer system for performing steps for the color gamut construction and visualization.

### DETAILED DESCRIPTION OF THE INVENTION

The present invention provides a new approach to the construction of a color gamut from color data points, which may represent printable colors of an ink system. Once constructed, the color gamut can be analyzed quantitatively, such as by calculating its volume. Moreover, the color gamut can be presented as a three-dimensional (3-D) object in a given color space on a display for visualization from different angles. Two color gamuts constructed from two sets of color data points, which may correspond to two different ink systems with different ink colors, can be displayed together so that their differences can be easily compared.

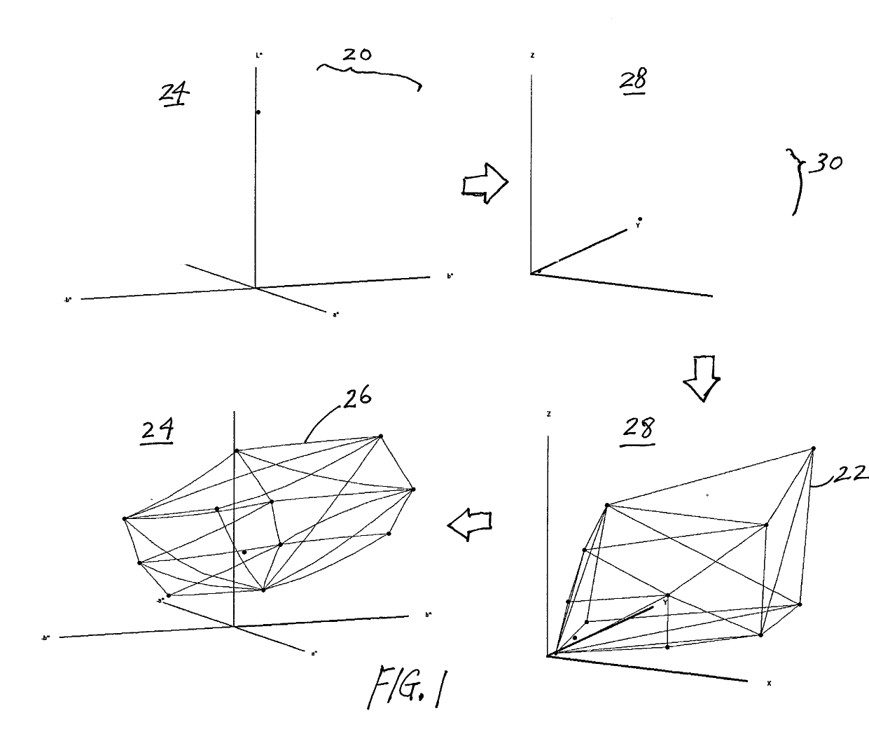

Turning now to the drawings, FIG. 1 is provided to illustrate a process according to the invention for constructing a color gamut from a set of given color data points 20. Each color data point represents a particular color. The colors associated with the color data points may be those of printed color samples. For instance, it is common in the printing industry to print solid primary colors, combinations of one solid primary color over another solid primary color (which are commonly called “traps”), and halftone scale cross charts showing different half-tone combinations of the printing inks. The printed color samples can be measured using a spectrophotometer to get the color components in a given color space for each of the color samples. It will be appreciated, however, that the color data points do not have to be measured from real printed color samples. For instance, the color data points may be artificially created for the sake of studying how the color gamut changes if the colors of the printing inks are changed.

In accordance with a feature of the invention, the construction of the color gamut for the color data points 20 involves the construction of a convex hull 22 in a desired additive color space 28 using the color data points. Suitable additive color spaces include, for example, the CIE XYZ color space and the CIE xyY color space. The rationale for deriving the color gamut from a convex hull constructed in an additive color will be described in greater detail below. Once this convex hull is constructed in the additive color space, it is transferred into a corresponding solid object 26 in a desired psychometric color space 24 and presented as the color gamut for the color data points 20. Suitable psychometric color spaces include, for example, the CIE Lab color space and the CIE Luv color space.

Depending on the original color space in which the data of the color data points 20 are presented, the color data may need to be transformed into the desired additive color space in which the convex hull 22 will be constructed. For instance, if the color data are measured in the CIE Lab space while the desired additive space is the CIE XYZ space as illustrated in FIG. 1, then a color transformation from CIE Lab to CIE XYZ is performed on the color data points to transform them into corresponding points 30 in the CIE XYZ space. On the other hand, if the color data points were measured in the target additive color space, then no color transformation is needed.

The convex hull is then constructed using the points 30 in the additive space 28. One suitable program for determining the convex hull from the color points is the “Qhull” program, which is available from the University of Minnesota. The convex hull 22 represents the color gamut for the color data points in the additive color space. Since color gamuts are preferably represented in a psychometric color space, which more closely correlates to how colors are perceived by human eyes, a transformation from the additive color space to the desired psychometric color space is applied to the convex hull 22. The transformation transforms the convex hull into a corresponding solid object 26 in the psychometric color space. This solid object, which represents the color gamut in the psychometric space 24, can then be displayed on a display device of the computer system for visualization or quantitatively analyzed in various ways.

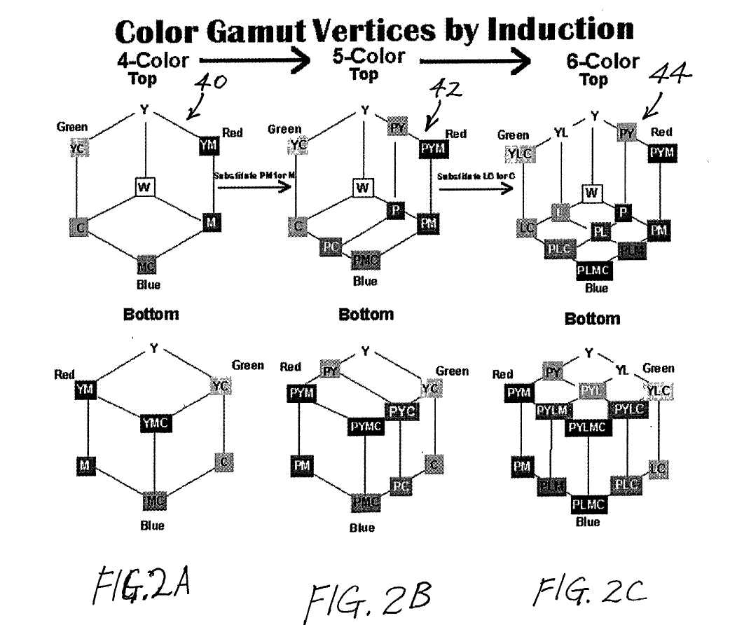

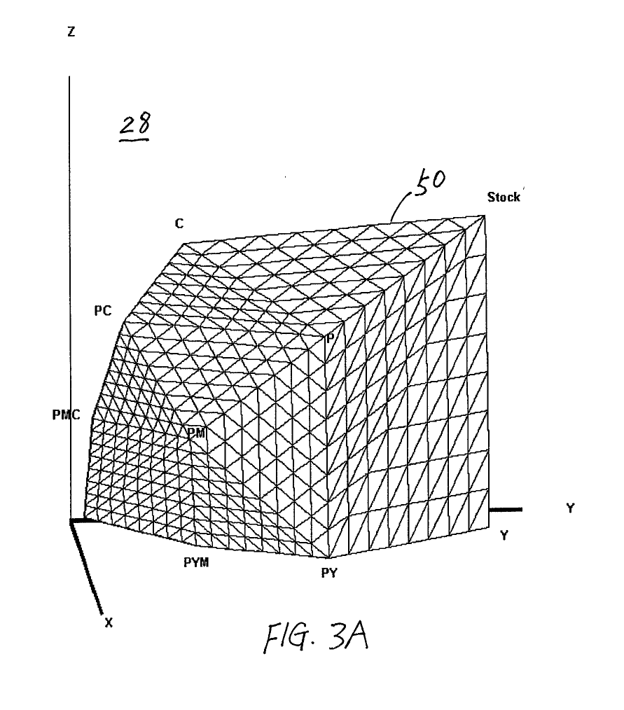

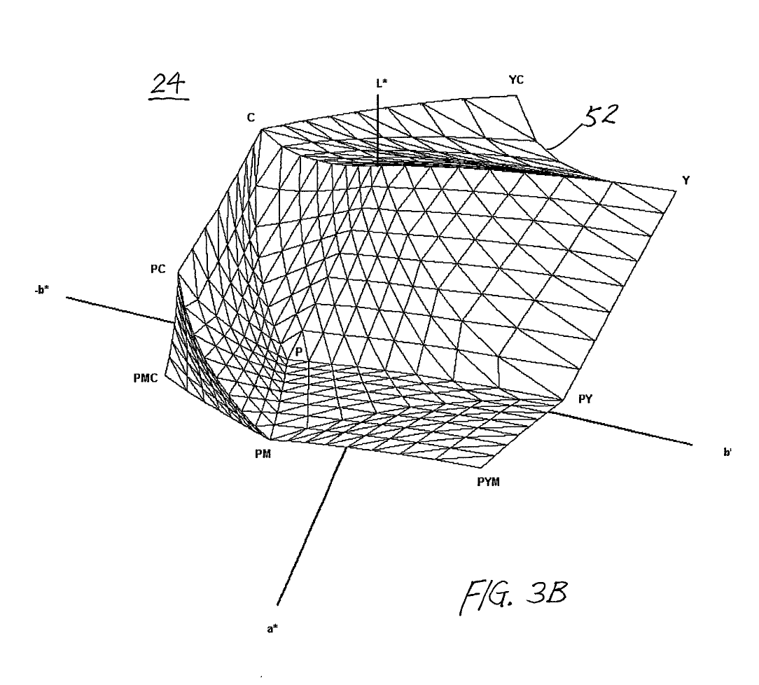

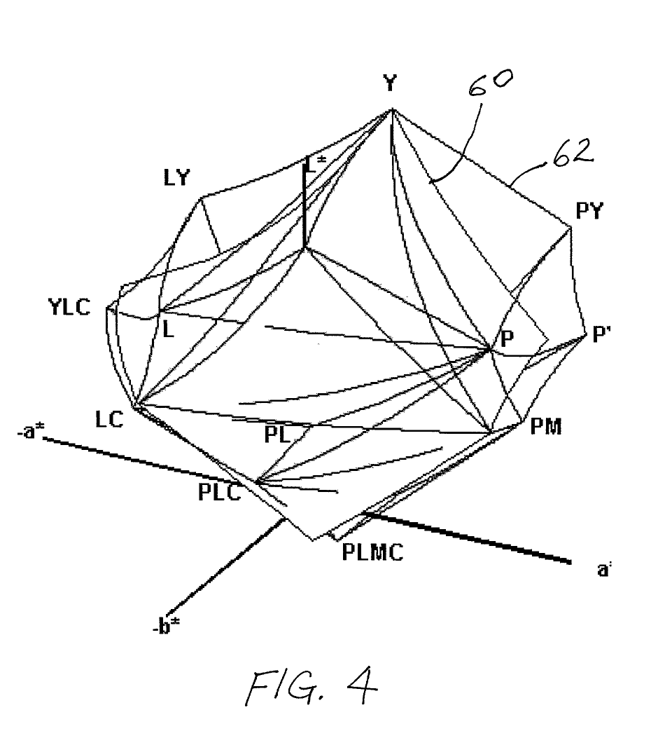

By way of example, FIGS. 2-4 illustrate a case study in which the gamut construction technique of the invention is used to determine and visualize the expansion in color gamut achieved by adding ink colors to the conventional 4-color ink system. FIG. 2 illustrates how the color data points used to generate the color gamuts shown in FIGS. 3 and 4 are derived. Those colors in FIG. 2 represent the result of an attempt to predict the vertices of the color gamuts for 5-color and 6-color ink systems by the method of induction. As described below in greater detail, however, some of the colors predicted by the induction method to be vertices actually turn out to be inside the color gamut solid constructed in accordance with the invention. In other words, the induction method cannot fairly predict the shape of the color gamuts. Thus, FIG. 2 serves to show how the connectivity between different color points is very difficult to predict based on existing color theories. This problem becomes even more difficult when the number of color data points increases or the trapped colors become combinations of fluorescent and non-fluorescent colors. In contrast, the color gamut construction technique of the present invention completely circumvents these difficulties because it does not rely upon any theoretical assumption of color connectivity. The only expectation of the approach of the present invention is that the vertices of the color gamut as presented in an additive space should be connected with straight lines.

FIG. 2A shows the top and bottom views of the conventional 4-color gamut cube 40, which has the colors white, yellow, cyan, magenta, red (yellow over magenta), green (yellow over cyan), blue (magenta over cyan), and black (in this case yellow over magenta over cyan) as the vertices. In FIG. 2(a), these colors are denoted as W, Y, C, M, YM, YC, MC, YMC, respectively.

FIG. 2B shows those colors predicted by induction to be at the vertices of a predicated color gamut structure 42 of a 5-color ink system that includes pink (P) in addition to Y, M, C, and black. Each color in FIG. 2B is identified by its ink composition and printing sequence. For instance, the color “PYM” is generated by printing pink over yellow over magenta.

FIG. 2C shows colors predicted by induction to be at the vertices of the predicted color gamut structure 44 for a 6-color ink system that adds pink and light cyan (LC) to the conventional Y, M, C, black colors. Again, each of the colors is identified by its ink composition and printing sequence.

According to the present invention, a color gamut is formed by constructing a convex hull in an additive space using the given color data points, and deriving the color gamut in a psychometric space from the convex hull. To illustrate this concept, FIG. 3A illustrates a convex hull 50 constructed in the CIE XYZ space using the color points shown in FIG. 2B for the 5-color ink system. In this particular example, all of the colors identified for the 5-color ink system in FIG. 2B except PYC become the vertices of the convex hull 50.

As can be seen in FIG. 3A, the convex hull 50 is a solid body with a surface having a plurality of vertices (identified by the corresponding colors) and flat faces defined by straight lines connecting the vertices. The reason for constructing the convex hull in an additive color space is that the vertices can be connected with straight lines. It is reasonable only in an additive color space to expect all the colors generated by different combinations of two given colors to fall on a straight line between the two given colors.

Once defined in the additive color space, the convex hull solid can be transformed into a corresponding solid object in a desired psychometric space. In the example shown in FIG. 3B, the psychometric space is the CIE Lab color space. The transformed solid body 52 represents of the color gamut of the 5-color ink system of FIG. 2B in the psychometric space.

In one embodiment, the software for determining the convex hull from the color data points returns three end points for each flat triangular face on the surface of the convex hull. Some of the triangular faces may be coplanar. Due to the non-linear transformation between the additive and psychometric color spaces, however, a flat face from the additive space may yield a curved face after the transformation, and more than the three end points are required to define the curved face in the psychometric space. To provide additional surface points for defining the curved faces in the psychometric space, each triangular face between three vertices of the convex hull in the additive space is divided into (or “tessellated” with) smaller triangles similar to the original face.

In the example shown in FIG. 3A, each face of the convex hall solid 50 is divided into sixty-four (64) smaller triangles. The end points of each smaller triangular face are recorded as part of the data defining the convex hull. After the color space transformation, the end points of the smaller triangular faces define the curved face between the three vertices of the color gamut solid 52. It will be appreciated that a better resolution of the curved faces of the color gamut can be achieved by dividing the corresponding faces into even smaller triangles. For instance, each face of the convex hull may be divided into 256 small triangles instead of 64.

As can be seen in FIG. 3B, the surface faces on the color gamut are curved rather than flat, and may be concave, convex, or saddle shaped. Nevertheless, since the surface of the color gamut is well defined by the surface points of the smaller triangles, the internal volume of the color gamut and its surface area can be calculated. The volume of a color gamut is a quantity that can be meaningfully used to compare different color gamuts.

One important aspect of color gamut construction of the invention is that it does not require a particular number of color data points for forming the convex hull. Color input is not limited to solid, 100% trap combinations of the process colors. For example, a half-tone cross-chart may have hundreds of printed half-tone color samples as well as the primary colors. All of those samples can be measured and entered into the computer system. The convex hull routine will automatically determine which color points will become the vertices of the convex hull and identify how the vertices are connected to form the convex hull. The resultant color gamut should be very similar in size and shape to the color gamut generated from a smaller number of color data points collected from measuring the printed solid primary color samples and color traps, with perhaps some refinement of the details of the faces of the gamut solid.

After a color gamut is constructed, it can be presented as a 3-D object in the psychometric space and displayed for viewing on a display device, such as a computer color monitor, digital projector, or the like. Furthermore, various quantitative analyses, such as calculating its volume or surface area, can be applied to the color gamut because it is well defined mathematically. The visualization and quantitative analyses can be used to effectively and meaningfully compare the color gamuts of various ink and display systems.

Preferably the color gamut is displayed with each point on its surface shown with a color that is close to the color associated with that point. Because the display device is likely to have a smaller color gamut different in some regions than the constructed color gamut, the coloring of some points on the ink color gamut displayed on the display device may differ somewhat from the true printed colors of those points. This is particularly true when using fluorescent process printing colors.

The color gamuts are shown in the Figures herein only as objects delineated by vertices and connecting curves and without colors. Nevertheless, those skilled in the art will have no difficulty in envisioning the color gamuts as being displayed as 3-D objects with interpolated colors on its curved surfaces. Rendering the gamut surfaces in full color is very useful because it enables the viewer to visualize which colors differ between two systems.

Displaying the color gamut constructed according to the invention as a 3-D object provides an immensely useful tool for visualizing the different aspects of the color gamut. For instance, the gamut can be rotated on the display to show different sides thereof. Displaying the color gamut from different angles can reveal information that will be difficult to extract otherwise. For instance, the 3-D view can show the height of the color gamut along the L axis of the CIE Lab space, which of course cannot be conveyed by a conventional plot of the color gamut as a projection on the a*-b* plane.

A very important and powerful application of color gamut visualization is to display two (or more) color gamuts together to contrast the differences and/or overlap between them. By way of example, FIG. 4 shows the color gamut for a 4-color ink system and the color gamut of a 6-color ink system together. The 4-color gamut 60 is constructed using the colors shown in FIG. 2A, while the 6-color gamut 62 is constructed from the colors shown in FIG. 2C. In this regard, it is interesting to note that four of those colors in FIG. 2C, namely PLM, PYL, PYLC, and PYLM, turn out not to be vertices of the color gamut. In other words, they fall inside the convex hull from which the color gamut is derived.

One way to facilitate a clear view of the differences between the two color gamuts is to display the smaller gamut as a colored solid and the larger gamut in the form of a wireframe, which may partially or completely enclose the solid of the smaller gamut. Alternatively, the larger gamut may be displayed as a hollow body with semi-transparent colored faces through which the smaller gamut solid can be seen. For illustration purposes, however, the 4-color gamut is shown in FIG. 4 as a solid with a white surface, while the 6-color gamut is shown as a wireframe. Nevertheless, it still can be seen that increasing the inks from four colors to six colors provides a significant expansion of the gamut size. A comparison of the calculated volumes of the 4-color and 6-color gamuts shows that the use of two additional colors increases the gamut volume by 50%.

Interestingly, there are small portions of the 4-color gamut that lie outside the 6-color gamut. This is evidenced by that some of curves connecting the vertices of the larger gamut have segments that are inside the solid of the smaller gamut and, as a result, are invisible in the illustration of FIG. 4. Thus, even though the 6-color ink system has a much larger gamut, there are colors that are better printed with the 4-color ink system.

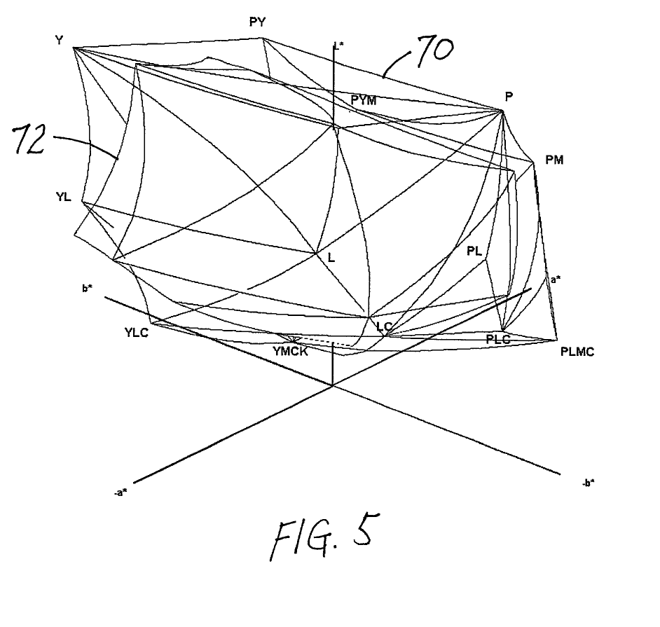

As another example, FIG. 5 shows a comparison of the color gamuts of two different 6-color ink systems. One of the 6-color ink systems is the BigBox Color™ of Hallmark Cards, Inc., and the other is the Hexachrome® of Pantone. The BigBox Color™ system uses pink (P) and light cyan (LC) in addition to cyan, magenta, yellow, and black (CMYK). In contrast, the Hexachrome® system uses orange and green in addition to CMYK. The color gamut 70 for the BigBox Color™ system is shown in FIG. 5 in the form of a wireframe, while the color gamut 74 for the Hexachrome® system is shown as a solid with white faces. When the color gamuts are viewed from the angle as shown in FIG. 5, it is seen that the gamut 70 of the BigBox Color™ system exhibits a significant expansion over the gamut 72 of the Hexachrome® system. This expansion is hidden in a conventional plot of the color gamuts as projections in the a*-b* plane of the CIE Lab color space.

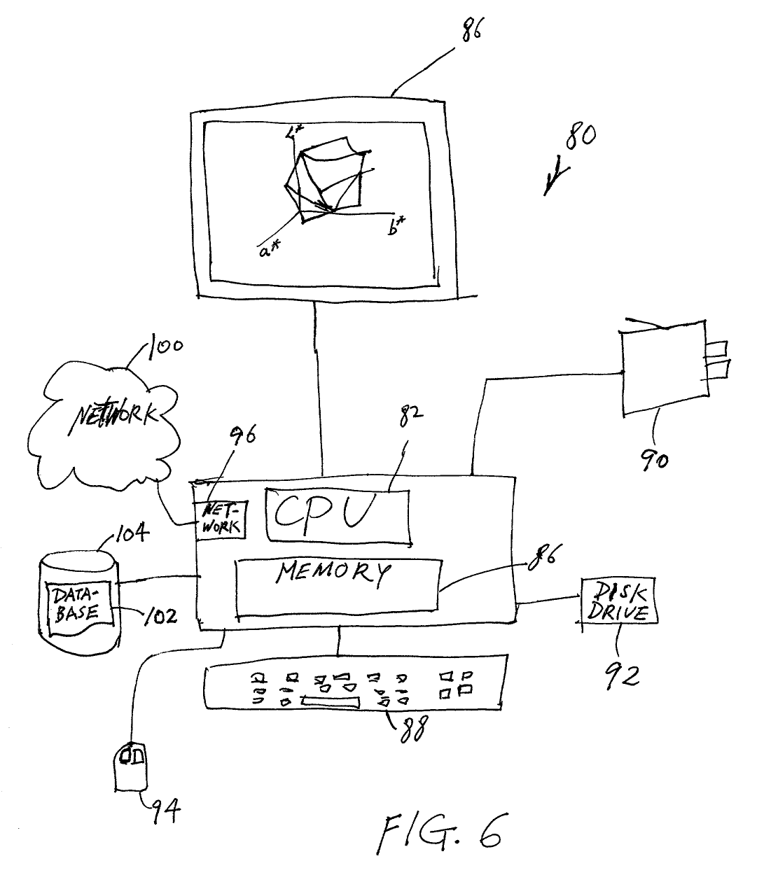

In one embodiment of the invention, the calculations and display of the color gamuts are performed by a properly programmed computer system. As shown in FIG. 6, the computer system 80 includes a central processing unit 82, a memory 84, input devices such as a keyboard 88, a mouse 94 and a disk drive 92, and output devices such as a color monitor 86 and a color printer 90.

The programming for the construction and display of color gamuts are stored in the memory 86 and comprises computer executable instructions for performing the various operations described. Input data, such as the color data points for constructing the color gamuts, may be received through the input devices. The computer may also include a network connection 96 to a computer network 100, such as a private network or the Internet, and data input and output may received and sent through the network connection.

In one embodiment, the computer also maintains a database 102 in a storage medium, such as a hard disk 104. The database 102 archives the color gamuts of different ink systems or display devices constructed in accordance with the invention. The color gamut data can be easily retrieved from the database 102 for use in various visual and quantitative analyses and comparisons.

In view of the many possible embodiments to which the principles of this invention may be applied, it should be recognized that the embodiment described herein with respect to the drawing figures is meant to be illustrative only and should not be taken as limiting the scope of invention.

What is claimed is:

1. A method of constructing a color gamut, comprising the steps of:
providing a plurality of color data points;
constructing a convex hull in an additive color space based on the color data points;
transforming the convex hull into a corresponding solid object in a psychometric color space;
presenting the solid object as a color gamut corresponding to the color data points.

2. A method as in claim 1, wherein the step of presenting includes displaying the color gamut as a first three-dimensional object on a display for visualization.

3. A method as in claim 2, wherein the step of displaying includes displaying a second color gamut as a second three-dimensional object on the display together with the first three-dimensional object for comparing said color gamuts.

4. A method as in claim 2, wherein the step of displaying displays the three-dimensional object as colored according to colors of the color gamut.

5. A method as in claim 1, wherein the step of constructing includes generating surface points on faces of the convex hull, and wherein the step of transforming transforms the surface points into corresponding surface points for defining curved faces of the color gamut.

6. A method as in claim 5, wherein the step of generating generates the surface points by subdividing faces of the convex hull into smaller faces.

7. A method as in claim 1, further including the step of calculating a volume of the color gamut.

8. A method as in claim 1, wherein the step of providing includes measuring printed color samples to generate the color data points.

9. A method as in claim 8, wherein the printed color samples are printed using at least one ink color in additional to yellow, cyan, magenta, and black.

10. A method as in claim 9, wherein the printed color samples are printed using a 6-color ink system.

11. A method as in claim 1, wherein the additive color space is the CIE XYZ color space.

12. A method as in claim 1, wherein the psychometric color space is the CIE Lab color space.

13. A computer readable medium having computer readable instructions for performing steps to construct a color gamut, comprising:
receiving a plurality of color data points;
constructing a convex hull in an additive color space based on the color data points;
transforming the convex hull into a corresponding solid object in a psychometric color space;
presenting the solid object as a color gamut corresponding to the color data points.

14. A computer-readable medium as in claim 13, wherein the step of presenting includes displaying the color gamut as a first three-dimensional object on a display for visualization.

15. A computer-readable medium as in claim 14, wherein the step of displaying includes displaying a second color gamut as a second three-dimensional object on the display together with the first three-dimensional object for comparing said color gamuts.

16. A computer-readable medium as in claim 14, wherein the step of displaying displays the three-dimensional object as colored according to colors of the color gamut.

17. A computer-readable medium as in claim 13, having further computer-executable instructions for performing the step of calculating a volume of the color gamut.

18. A computer-readable medium as in claim 13, wherein the color data points are generated by measuring printed color samples printed using at least one ink color in additional to yellow, cyan, magenta, and black.

19. A computer-readable medium as in claim 13, wherein the additive color space is the CIE XYZ color space.

20. A computer-readable medium as in claim 13, wherein the psychometric color space is the CIE Lab color space.
